(19) United States
(12) Patent Application Publication
(10) Pub. No.: US 2011/0161391 A1
(43) Pub. Date: Jun. 30, 2011

(54) FEDERATED DISTRIBUTED WORKFLOW SCHEDULER

(76) Inventors: Nelson Araujo, Redmond, WA (US); Roger S. Barga, Bellevue, WA (US); Di Guo, Redmond, WA (US); Jared J. Jackson, Sammamish, WA (US)

(21) Appl. No.: 12/650,267

(22) Filed: Dec. 30, 2009

(51) Int. Cl. G06F 15/16; G06Q 10/00; G06Q 30/00; G06Q 50/00

(52) U.S. Cl. 709/201; 705/301; 705/80

(57) ABSTRACT

A computer may function as a broker that brokers execution of portions of a workflow. The broker computer may have a processor and memory configured to receive the workflow via a network. The workflow may have a corresponding SLA document that has rules governing how the workflow is to be executed. The broker computer may identify discretely executable sub-workflows of the workflow. The broker computer may also obtain information describing computing characteristics of each of a plurality of service providers (e.g., computation clusters, cloud services, etc.) connected with the broker computer via the network. The broker computer may select a set of the service providers by determining whether their respective computing characteristics satisfy the SLA. The broker computer may pass the discretely executable sub-workflows to the selected set of service providers. The workflow is thus executed, in distributed federated fashion, transparently to the user submitting the workflow.

### BACKGROUND

Workflow systems, such as Microsoft Corporation's Workflow Foundation, implementations of Workflow Open Service Interface Definition, Open Business Engine, Triana, Karajan, and systems built on workflow technology (e.g., Trident from Microsoft Corporation), have been in use for some time. Recent developments have enabled workflows to be executed in distributed fashion, for example, on a computing service grid. For example, see U.S. Patent application Ser. No. 12/535,698 (Distributed Workflow Framework) for details on how smart serialization points can be used to divide a workflow into pieces that can be distributed to various computers, cloud services, web-based services, computing clusters, etc. (to be collectively referred to herein as “service providers”).

While workflows can be divided into pieces and those pieces may be distributed to be executed by various services, sometimes referred to as workflow federation, distribution has heretofore been performed manually or has been centrally controlled. That is, a user wishing to execute a workflow using various computing clusters may specifically designate different clusters (or services or resources) to handle particular parts of the user's workflow. In other words, it has not been possible for a user to merely specify high-level execution requirements of a workflow (e.g., time, cost, etc., provider constraints, etc.) and allow allocation of workflow pieces to be handled transparently. That is, it would be helpful if, among other things, a user could submit a workflow with high-level execution guidance and/or service level agreement(s) and receive results of execution of the workflow without dealing with the details of how the workflow is distributed to different service providers and which service providers handle the parts of the workflow.

Techniques related to federated distributed workflow scheduling are discussed below.

### SUMMARY

The following summary is included only to introduce some concepts discussed in the Detailed Description below. This summary is not comprehensive and is not intended to delineate the scope of the claimed subject matter, which is set forth by the claims presented at the end.

Described herein are computing devices and methods performed thereby. A computer may function as a broker that brokers execution of portions of a workflow. The broker computer may have a processor and memory configured to receive the workflow via a network. The workflow may have a corresponding SLA document that has rules governing how the workflow is to be executed. The broker computer may identify discretely executable sub-workflows of the workflow. The broker computer may also obtain information describing computing characteristics of each of a plurality of service providers (e.g., computation clusters, cloud services, etc.) connected with the broker computer via the network. The broker computer may select a set of the service providers by determining whether their respective computing characteristics satisfy the SLA. The broker computer may pass the discretely executable sub-workflows to the selected set of service providers. The workflow is thus executed, in distributed federated fashion, transparently to the user submitting the workflow.

### BRIEF DESCRIPTION OF THE DRAWINGS

The present description will be better understood from the following detailed description read in light of the accompanying drawings, wherein like reference numerals are used to designate like parts in the accompanying description.

FIG. 1 shows an example workflow 100.

FIG. 2 shows a system for federated or distributed workflow execution.

FIG. 3 shows an example service level agreement (SLA) 160 that may be associated with a workflow.

FIG. 4 shows another view of a workflow brokering system.

FIG. 5 shows an example of service providers handling parts of a workflow.

FIG. 6 shows a table 220 for storing data about various providers.

Many of the attendant features will be explained below with reference to the following detailed

FIG. 7 shows an example design of factory computer 202.description considered in connection with the accompanying drawings.

### DETAILED DESCRIPTION

Embodiments discussed below relate to federated distributed workflow scheduling. Workflow execution is federated in that different service providers (e.g., compute clusters, single servers, web-based services, cloud-based storage services, etc.) are used to execute parts of a workflow. As will be described, various techniques are used to determine how to—transparently to a user—distribute parts of a workflow for execution.

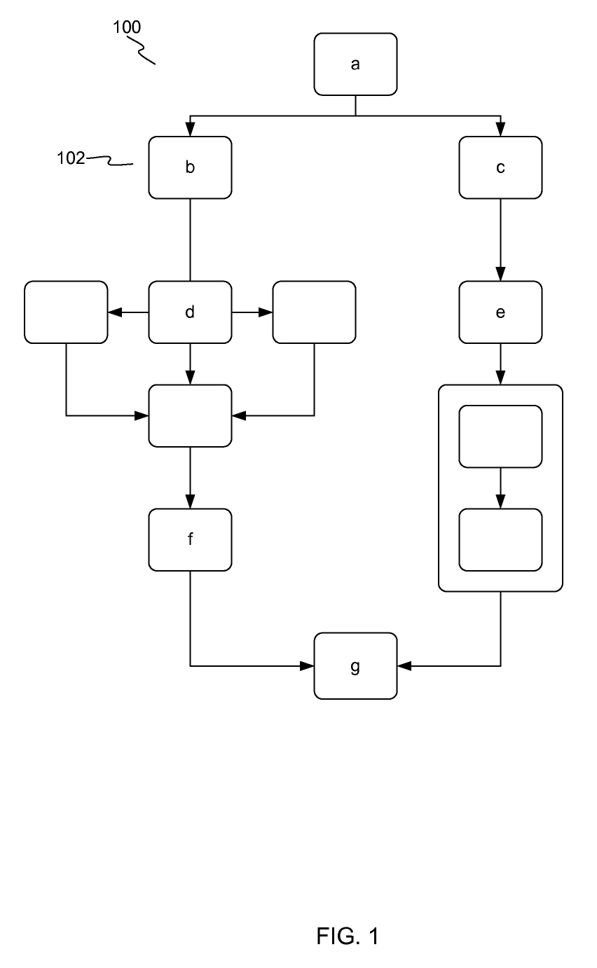

FIG. 1 shows an example workflow 100. The term “workflow” is well understood in the field of computer programming, however, for ease of discussion, workflows herein will be considered to be a collection of discrete activities (e.g., tasks) 102 whose execution is tracked by a workflow engine or system that executes workflows. Workflows may be written in a variety of available workflow languages. Workflows are generally persisted and their parts may execute concurrently or over extended periods of time. State of execution of a workflow may also be tracked and persisted. A workflow usually has a start state or activity, and an end state or activity, with various paths of execution between activities to the end state. Branches of logic, loops, conditional nodes, and other flow control constructs can be provided to allow parallel execution paths. Activities of a workflow may communicate by messages, emails, HTTP exchanges, SOAP (simple object access protocol), etc. Some workflow systems may have a workflow engine or manager that coordinates communication between activities. A workflow system may perform intra-activity communications using special-purpose protocols and the like. For an example of a distributed or federated workflow system, see BioPipe, GridBus, OSWorkflow, among other systems. Examples of workflows may be found at www.myexperiment.org/workflows, as of the filing date of this application and earlier. Note that in FIG. 1, various of the activities 102 are labeled with letters, which will be referred to throughout as examples.

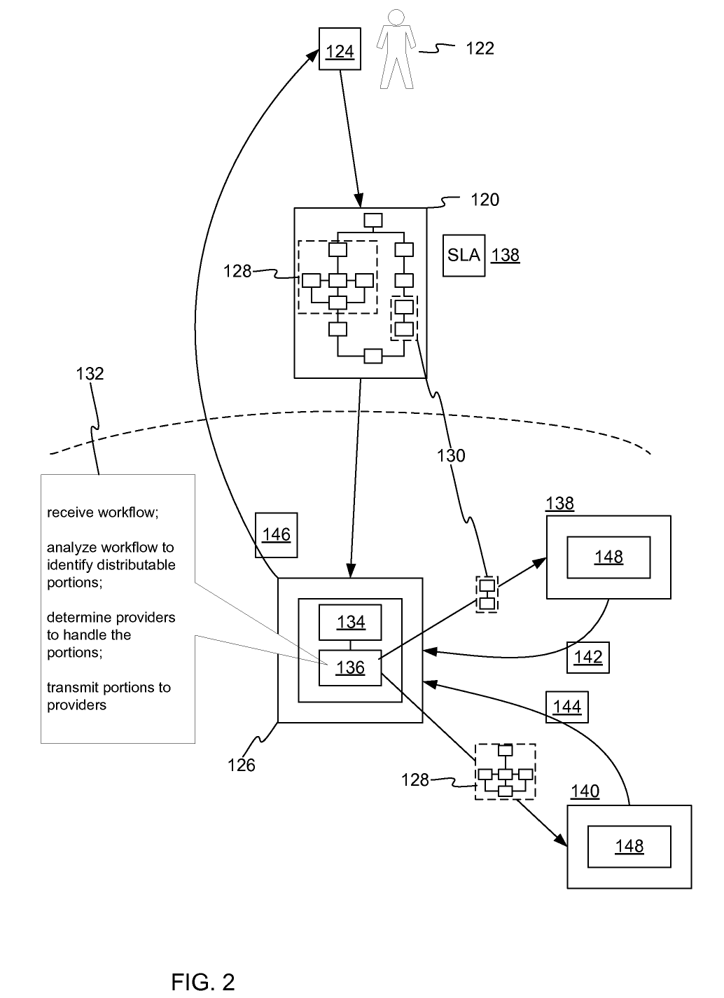

FIG. 2 shows a system for federated or distributed workflow execution. A workflow 120 may be authored by user 122 using a client computer 124. Not show, but assumed, is a data network for service providers, computers such as client 124, and others, to exchange data. Via the network, manual input, or other means, the client 124 submits the workflow 120 to a broker or factory computer/server 126. Note that the workflow may have parts, also called sub-workflows, such as sub-workflows 128 and 130. In one embodiment, the sub-workflows may be specifically defined by the user 122, for example with a graphical tool for authoring workflows. For example, a user may interact with a graphic depiction of the workflow 120 to select a part of the workflow and group the selected activities. The tool may add smart serialization markers, depicted by the dashed lines around sub-workflows 128 and 130, to the workflow 120 (for instance, embedded in the code of the workflow 120, or in an accompanying XML manifest).

Upon receiving workflow 120, the broker computer 126 performs a process 132 for handling the workflow 120. After receiving the workflow 120, the broker computer 126 analyzes the workflow 120 to identify distributable portions of the workflow. In one embodiment, user-defined markers are found (for example, smart serialization points described in the U.S. patent application mentioned in the Background). In another embodiment, the broker computer 126 may analyze the workflow 120 to identify parts that may be grouped, for example, identifying activities that share or access same data, activities that are adjacent, information about past executions of the workflow, and so on. In one embodiment the broker computer 126 may have an analyzer component 134 that performs this breakdown analysis. Note that sub-workflows may be broken down recursively to identify discretely distributable sub-sub-workflows (sub-workflows of sub-workflows), and so on.

The broker computer 126 may then determine which service providers will handle which determined portions of the workflow 120. In one implementation, the determining may be performed by delegation component 136. Detail of this step will be described further below. Briefly, the broker computer 126 may take into account various rules associated with the workflow 120, for example, a service level agreement (SLA) 138 in electronic form and packaged with or linked to the workflow 120, rules or suggestions authored by the user 122, and so on. The rules may specify requirements and/or preferences related to the workflow 120, the user 122, an organization in which the user 122 participates, etc. The rules may specify quality of service requirements for the entire workflow 120 or parts thereof. The rules may specify time minimums/maximums, various cost limitations such as maximum total cost, maximum cost per provider, preferred providers, national boundary limitations (e.g., execute only North American countries), and so on. The broker computer 126 applies the rules to known information about the workflow 120 and the available service providers to identify preferable providers for the various parts or sub-workflows such as sub-workflows 128 and 130 (and possibly sub-sub-workflows). The broker computer 126 then transmits the sub-workflows (or references thereto) to the determined service providers such as provider 138 and 140.

The providers 138 and 140 (that is, one or more computers thereof) receive the sub-workflows 128 and 130. In one embodiment, a provider may have its own broker computer configured similar to broker computer 126, and may in turn attempt to further breakdown and distribute execution of its sub-workflow or workflow part. Assuming that service provider 138 does not have a broker or has determined further distribution is not possible, the provider 138 (via one or more of its computers) executes its sub-workflow. When finished (or in stages of completion), all or part of the results 142 and 144 of local execution are passed back to the broker computer 126, which may collect results, may possibly perform additional processing (e.g., execution parts of the workflow 120 per results 142 and 144), or otherwise form a formal result 146 to be returned to the client 124. Note that results might be stored by one or more service providers and a link to the results may be returned to the client 124. One or more providers might also serve as an inputs or results directory, where the broker computer 126 (or a service provider storing the results) sends to other providers links to inputs, returns to the client a result link pointing to the results directory, and when the results directory receives a request for the result link from the client, either the result directory acts as a conduit for the results (reading them from a service provider and forwarding them to the client) or the result directory redirects the client to the results on the service provider. For instance, if the workflow 120 creates a large set of vector data, the workflow 120 may cause a provider to store such data.

A provider may be provisioned with a workflow component 148 that is capable of parsing a sub-workflow, e.g., by compiling or interpreting corresponding code, by passing the sub-workflow to a local workflow engine (e.g., a locally executing instance of Windows Workflow Foundation). A provider may also have an interface or shim module to translate between the sub-workflow per se (the workflow system) and backend facilities for processing. For example, an interface may translate a workflow activity into a series of floating point matrix computations and may translate the result of such computation back to the workflow system, or even to non-automated means, such as performing the tasks by human interaction. In one example, suppose that the workflow result is a weather forecast of the North America for tomorrow. The system might require a human to execute a visual inspection of the results to acknowledge that it is indeed a map with weather patterns on it, before public display such as in TV news. That interaction is the task to be executed and the acknowledgment is the result of the task.

As mentioned above, the broker computer 126 may obtain information about providers to help in its decision making (rule application) process. In one embodiment, a provider may have a module that is able to obtain and communicate to the broker computer 126 relevant information about the provider's costs, computation abilities, storage abilities, etc.

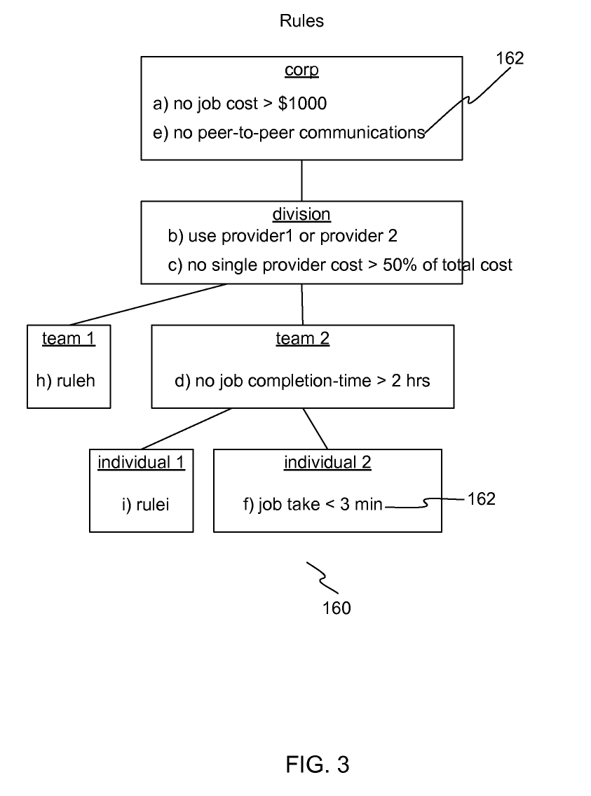

FIG. 3 shows an example service level agreement (SLA) 160 that may be associated with a workflow. The SLA 160 may be thought of as an electronic analogue to the type of service agreements made between computation vendors and their customers. That is the SLA may govern technical and/or cost agreements between serviced providers and a customer (e.g. the organization to which user 122 belongs). In one embodiment, the SLA 160 is in the form of a hierarchical arrangement of rules 162. Rules 162 at higher levels of the hierarchy may have priority over rules 162 the lower levels of the hierarchy. Facilities may be provided, for example digital signature infrastructure, to allow different organizational units to control the rules at respective levels of the hierarchy of the SLA 160. Rules 162 at a given level may also be prioritized. For example, rule (a) may have priority over rule (e) at the top “corp” level of the hierarchy. The rules (a) to (f) are self-explanatory and serve only as examples; any type of rule may be specified. Generally, a rule may include logic or conditional constructs about how workflows in general are to be handled for the organization or entity that owns the SLA 160. Of course, if individual 2 submits a workflow, the rules of team 1 and individual 1 would not be applicable to the workflow. As discussed later, a mechanism to allow overriding a rule may also be provided. It should be noted that an SLA is a concept, not an implementation, and generally it can mean anything both parties can agree to. The broker computer may have modules to understand standard, provider-made, and custom-made SLAs. In one embodiment, a provider may have its own metric (e.g., “number of calories consumed by all the people involved in the job”) as something that can be transmitted from the provider internals to the customer's decision logic. In this example, now the customer has a new item that it can add to its logic, e.g., “maximum total human calories burned: 9999”.

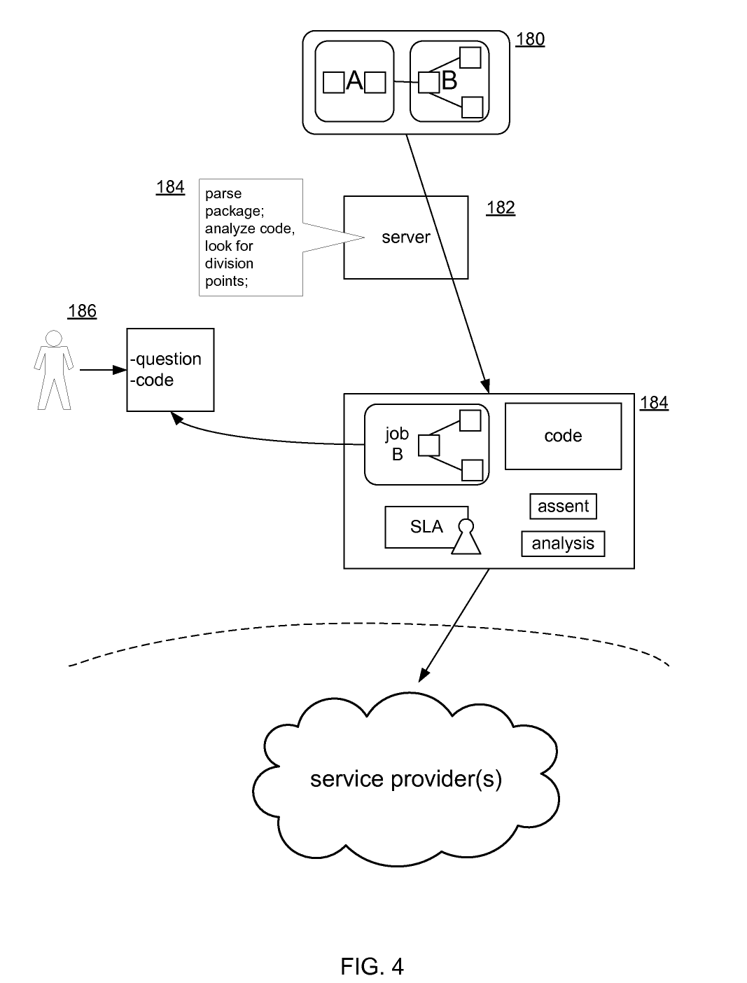

FIG. 4 shows another view of a workflow brokering system. A workflow 180 is received by a brokering server 182 or cluster. In this embodiment, the brokering server 182 identifies the entity submitting the workflow 180. The brokering server 182 performs a process 184 that may include parsing a package containing the workflow 180, analyzing the workflow to find divisions of the workflow, for example parts A and B. The brokering server 182 may then perform analysis, as described above, for identifying which service providers are to perform which parts of the workflow 180. For example, the brokering server 182 may analyze the workflow 180 to estimate likely compute requirements for parts of the workflow 180. The brokering server 182 may also find clues about compute needs added to the workflow by the workflow's author. For instance, the author may have indicated that the activities in part B of the workflow must be executed in under one day, or may have included an estimate about the maximum number of floating point operations to be performed or the minimum amount of RAM required to perform the part B. In some cases, the workflow 180 may have a rule attached that conflicts with one of the other rules in the SLA. In one embodiment, the workflow 180 will not be allowed to execute. In another embodiment, the brokering server 182 will seek permission to override the SLA rule by allowing an authorized person to sign an override certificate or the like (an override may also be performed by another program or system outside the workflow system, such as a human resources or finance program). The part B may then be included in a package 184 which may include the SLA, the part B itself, corresponding code, assent, analysis added by the brokering server 182, and so on. The package 184 is then submitted to the selected service provider.

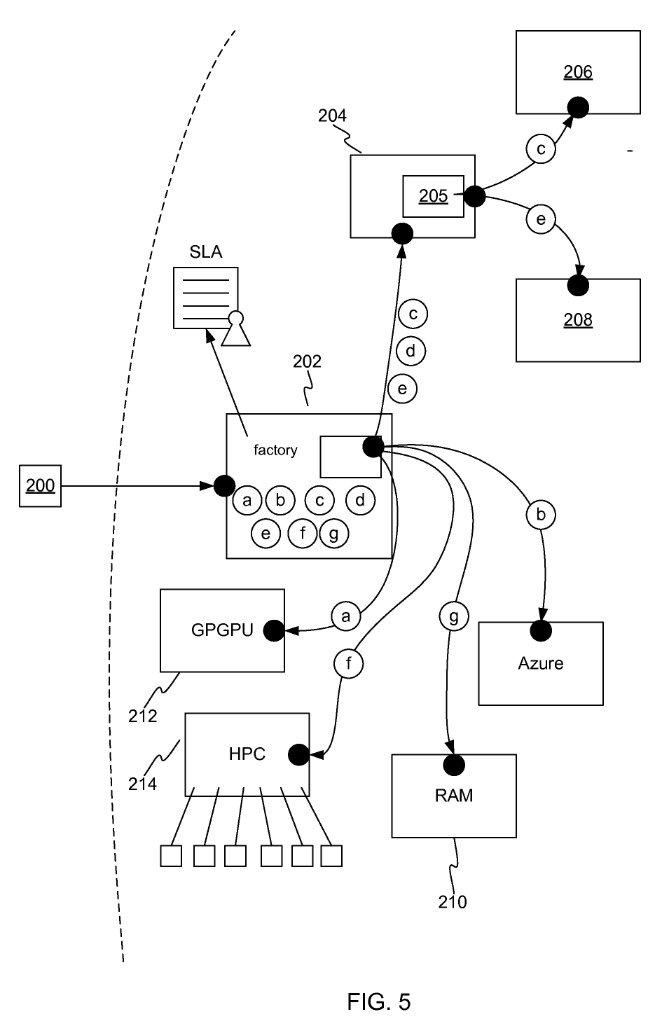

FIG. 5 shows an example of service providers handling parts of a workflow. A client computer 200 submits a workflow. The broker or factory computer 202 breaks it into parts (a) to (g). The factory computer 202 selects various service providers to handle the workflow parts. For example, the factory computer 202 selects the best providers in terms of cost and completion time, and then filters out any providers that somehow violate the rules of the SLA. The process may be repeated until a final set of service providers is obtained. In the example, parts (c), (d), and (e) are transmitted to provider 204. Provider 204 has a workflow component 205 that further distributes part (c) to provider 206 and part (e) to provider 208. Part (b) is distributed to the “Azure” provider, part (g) to a generic provider 210 that specializes in storage. Part (a) is distributed to provider 212 which provides virtual general graphics processing. Part (f) is transmitted to a high performance computing provider 214. As discussed previously, the results of the various processing may be returned to the client 200 by way of the factory computer 202.

The black dots in FIG. 5 represent communication links. Because the providers may have different means of communication, a workflow protocol may be used to allow the broker or factory computer 202 to exchange workflow parts and data with the various service providers. A simple protocol may be used on top of other common protocols such as HTTP, SOAP, etc. Each provider may have an interface (black dot) that translates between the workflow protocol and any of the underlying protocols.

The factory 202 may also act as a central coordinator for execution by the various service providers. For example, if a first provider has a sub-workflow whose input is the output of second provider's sub-workflow execution, the factory 202 may be responsible for handing the output of the second provider to the first provider, or it may facilitate a handshake between the first and second provider to allow them to exchange the data directly. The factory 202 may also coordinate the timing of various providers' execution of sub-workflows. For instance, the factory 202 may suspend one provider based on feedback from another provider. The factory 202 may initiate one provider only when another provider has completed its sub-workflow. In general, known techniques for the coordination and synchronization performed by a single-machine workflow engine may be used for distributed coordination and synchronization.

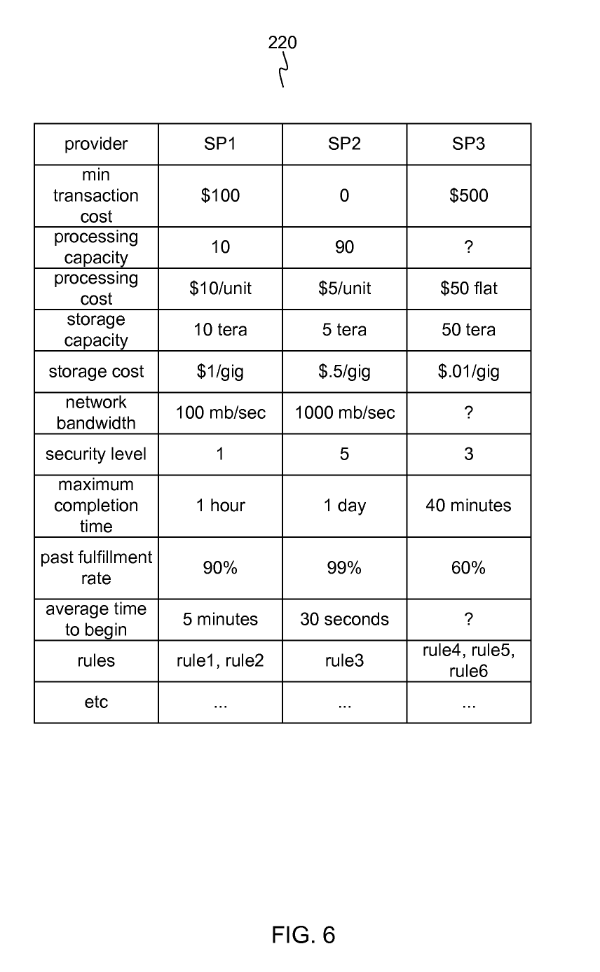

FIG. 6 shows a table 220 for storing data about various providers. As described earlier, when deciding how to allocate workflow parts to service providers, the broker may need to obtain information about the properties, costs, capacities, etc., of the various providers. Static or infrequently changing properties may be stored in a table such as table 220. The table 220 may also be implemented as a cache. For example, when the broker is evaluating a workflow, it may query candidate providers for information of the type found in table 220. Such queried information may be stored until it becomes stale or is updated. In sum, the broker may use a combination of stored static information about providers as well as dynamic data regarding current capabilities of providers queried at evaluation time. This information may be “plugged in” to the various SLA rules or other rules associated with the workflow to identify providers best suited for handling parts of a workflow. For example, if an SLA rule requires that a job must complete in less than 3 hours, and a “maximum completion time” of a provider is 1 hour, then that provider might be selected based on its property that satisfies the rule. If several providers meet the requirement, e.g. SP1 and SP2, then another rule may be consulted, for instance, a SLA rule may specify “minimize cost”, and the properties of SP1 and SP3 may indicate that SP3 would be the less costly provider in 3 hours of completion time. Rule priority may also affect the outcome; if the time rule has higher priority than the cost rule, then SP1 might be chosen, even if its cost is higher than SP3 (again, assuming that SP1 satisfies the other rules such as total cost, etc.).

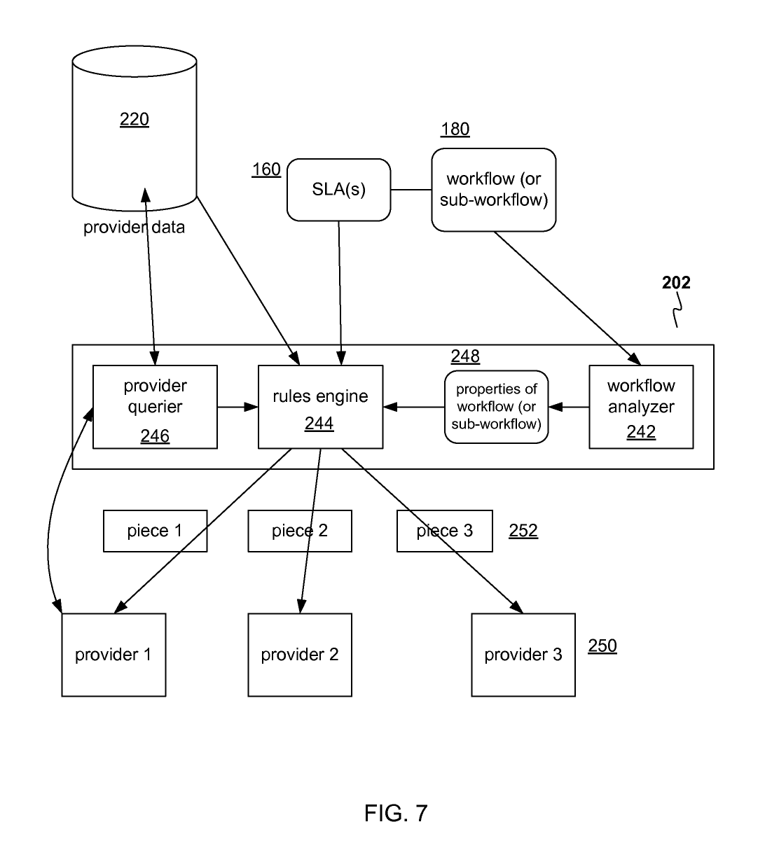

FIG. 7 shows an example design of factory computer 202. It will be appreciated by those skilled in software engineering that the particular divisions of functionality in a system may vary and it is the overall accomplishments and general methods of a system that are of note. The factory computer 202 may be any of a variety of known types of computers, provided with processor(s), memory, storage, network interfaces, an operating system, application software, and other well-known components. These components may be configured, by way of programming, to provide the factor computer 202 with a workflow analyzer 242, a rules engine 244, and a provider querier 246, among others. The workflow analyzer 242 may analyze workflow 180 to identify properties 248 of the workflow, such as divisions of the workflow, requirements of the divisions, estimated resources required, specifically designated preferred providers, and so on. The provider querier 246 may obtain information about providers 250 from provider data table 220 and/or from providers 250 directly. The provider querier 246 may pass properties of the various providers to the rules engine 244. The rules engine 244 may apply logical rules to the provider properties to identify the preferred providers 250 for the pieces 252 of the workflow 180. Any of the providers 250 may themselves have a server configured as factory computer 202. Ultimately, the user or client (or other provider) that supplied the workflow 180 receives the results of the distributed federated execution of the workflow pieces 252.

Embodiments and features discussed above can be realized in the form of information stored in volatile or non-volatile computer or device readable storage media. This is deemed to include at least media such as optical storage (e.g., CD-ROM), magnetic media, flash ROM, or any current or future means of storing digital information. The stored information can be in the form of machine executable instructions (e.g., compiled executable binary code), source code, bytecode, or any other information that can be used to enable or configure computing devices to perform the various embodiments discussed above. This is also deemed to include at least volatile memory such as RAM and/or virtual memory storing information such as CPU instructions during execution of a program carrying out an embodiment, as well as non-volatile media storing information that allows a program or executable to be loaded and executed. The embodiments and features can be performed on any type of computing device, including portable devices, workstations, servers, mobile wireless devices, and so on.

1. A method having steps performed by one or more computers, the steps of the method comprising:
receiving a workflow, the workflow defining a flow of discrete activities and paths of execution connecting the activities such that some activities can be executed concurrently, the workflow having a corresponding electronically-stored representation of a service level agreement (SLA), the SLA comprising a set of rules governing execution of the workflow;
analyzing the workflow to identify sub-workflows that can be executed independently, a sub-workflow comprising a set of one or more of the activities each connected on a path of execution of the workflow;
obtaining information about a plurality of online service providers, each online service provider comprising one or more computers that together provide an online service;
selecting different service providers to perform the sub-workflows, respectively, where the service providers are selected based on the set of rules in the SLA as applied to the information about the online service providers; and
transmitting the sub-workflows via a network to the corresponding online service providers to execute the sub-workflows.

2. A method according to claim 1, wherein the information about the plurality of online service providers is obtained by querying the online service providers.

3. A method according to claim 1, wherein the set of rules comprise a hierarchy wherein the rules are of varying priority and the selecting comprises applying the rules to the information about the service providers such that higher priority rules are satisfied before lower priority rules.

4. A method according to claim 3, wherein the information about the online service providers comprises information about computing resources of the online service providers and costs of the computing resources.

5. A method according to claim 1, further comprising obtaining approval to override a rule in the SLA.

6. A method according to claim 1, wherein the SLA and the workflow are included in a package and the SLA has an attached digital signature.

7. A method according to claim 1, wherein the sub-workflows are identified by markers added to the workflow by a user.

8. One or more computer-readable storage media storing information to enable a computer to perform a process for brokering portions of workflow to different service providers, the process comprising:
receiving the workflows from different users, each workflow comprising interconnected activities and connections between the activities;
analyzing the workflows to identify discrete portions thereof that can be independently executed;
for each workflow, accessing rules corresponding to the workflow that specify constraints that must be satisfied by any service provider that executes all or part of the workflow, using the rules to determine which of the service providers satisfy the rules, and transmitting the portions of the workflow to the respectively determined service providers; and
receiving from the service providers results of executing the portions of the workflow.

9. One or more computer-readable storage media according to claim 8, wherein the process is performed by a broker computer that receives the workflows from client computers and, for a given workflow, returns to the corresponding client computer results obtained from the service providers, wherein the client computer does not communicate with the service providers.

10. One or more computer-readable storage media according to claim 8, wherein one of the rules of a workflow specifies a cost constraint and/or a time constraint for the one of the workflows.

11. One or more computer-readable storage media according to claim 8, wherein a first portion of a workflow is transmitted via a network to a first service provider, and the service provider analyzes the portion and identifies a second service provider to perform a sub-portion of the portion of the workflow.

12. One or more computer-readable storage media according to claim 8, wherein the process is performed by a broker computer between client computers that submit the workflows to the broker computer and the service providers, such that the client computers communicate with the broker computer and not the service providers to execute the workflows and to receive results of the workflows executing.

13. One or more computer-readable storage media according to claim 8, wherein a workflow includes processing specifications and the determining comprises attempting to identify service providers that satisfy the processing specifications.

14. One or more computer-readable storage media according to claim 8, wherein the analyzing comprises finding markers in the workflows that demarcate the discrete portions of the workflows, a discrete portion comprising a plurality of interconnected activities.

15. A method performed by a computing device comprising a broker computer that brokers execution of portions of a workflow, the broker computer comprising a processor and memory configured to perform the method, the method comprising:
receiving the workflow via a network, the workflow having a corresponding SLA document;
identifying discretely executable sub-workflows of the workflow;
obtaining information describing computing characteristics of each of a plurality of service providers connected with the broker computer via the network;
selecting a set of the service providers by determining whether their respective computing characteristics satisfy the SLA document; and
passing the discretely executable sub-workflows to the selected set of service providers.

16. A method according to claim 15, wherein the computing characteristics include storage characteristics, computing capacity characteristics, and/or cost characteristics.

17. A method according to claim 15, wherein the SLA document comprises a plurality of rules arranged in a hierarchy wherein rules have priority relative to other rules according to rank within the hierarchy.

18. A method according to claim 15, wherein one of the service provider receives a sub-workflow, identifies discretely executable sub-sub-workflows therein, and uses the SLA document to identify another service provider to execute one of the sub-sub-workflows.

19. A method according to claim 15, further comprising requesting an estimate for completion of a sub-workflow from one of the service providers, receiving the estimate, and selecting the one of the service providers based in part on the estimate.

20. A method according to claim 15, wherein the SLA document comprises static rules that exist prior to receiving the workflow and dynamic rules computed after receiving the workflow.
